(19) United States
(12) Patent Application Publication
(10) Pub. No.: US 2017/0160883 A1
(43) Pub. Date: Jun. 8, 2017

(54) IMPLEMENTING APPLICATION JUMPS

(71) Applicant: Alibaba Group Holding Limited, George Town (KY)

(72) Inventor: Zhijun Yuan, Hangzhou (CN)

(21) Appl. No.: 15/363,685

(22) Filed: Nov. 29, 2016

(30) Foreign Application Priority Data
Dec. 4, 2015 (CN) 201510885702.7

(51) Int. Cl. G06F 3/0482

(52) U.S. Cl. CPC G06F 3/0482

(57) ABSTRACT

Implementing app jumps is disclosed, including: receiving an application (app) jump interface trigger with respect to a source object; extracting a plurality of target app destinations from a set of jump association information corresponding to the source object, wherein at least a portion of the set of jump association information corresponding to the source object is determined based at least in part on historical app usage data; presenting the plurality of target app destinations corresponding to the source object in a jump interface; receiving a selection associated with a selected target app destination in the jump interface; and performing a jump to the selected target app destination using jump link information corresponding to the selected target app destination, wherein the jump link information is included in the set of jump association information corresponding to the source object.

### CROSS REFERENCE TO OTHER APPLICATIONS

This application claims priority to People's Republic of China Patent Application No. 201510885702.7 entitled AN APP CONTROL METHOD, AND A METHOD AND A DEVICE FOR APP JUMP ASSOCIATION CONFIGURATION filed Dec. 4, 2015 which is incorporated herein by reference for all purposes.

### FIELD OF THE INVENTION

The present application relates to application control technology. Specifically, the present application relates to techniques for configuring application jump associations and for generating application jump association information.

### BACKGROUND OF THE INVENTION

Multiple applications (apps) are generally installed on personal computers, smartphones, and other terminal devices. Apps provide weather, shopping, chatting, picture-taking, email-sending, and many other convenient service functions.

To complete a series of related tasks, a user often switches among multiple apps. The following is an example of how a user may switch among multiple apps to complete a series of related tasks: a user plans to watch a movie in the evening after dinner, so the user first buys a movie ticket with a movie app on his smartphone. Before dinner, he makes a reservation at a restaurant near the movie theater using a restaurant and/or restaurant reservation app. Before the movie begins, he uses a taxi app to call a taxi to transport him to the movie theatre. After entering the theater, he uses a ticket app to pick up his ticket and find a seat in the movie theatre. After he finishes watching the movie, he uses a movie review app to make comments on the movie that he had just watched. As such, a user can perform a series of actions that requires switching among multiple apps.

Conventionally, the user can jump between different apps on his or her device using a taskbar element of the user's mobile device's operating system. For example, a taskbar element provided by mobile operating systems such as iOS or Android may display a list of recent tasks (e.g., such as recently accessed apps). By clicking on one of the recently accessed apps, the user is able to jump from one app to another.

Recently accessed apps, which are displayed by the taskbar element, are provided from the mobile device's system layer and typically only contain apps that were opened recently. Moreover, recently accessed apps usually cannot embody differences in jump destinations between different apps and between different specific app interfaces. As a result, the user generally needs to execute additional operations on top of making selections with respect to the recently accessed apps in order to achieve the necessary jump functions. Thus, using recently accessed apps as a means of switching between apps is low in efficiency and results in poor user experiences.

### BRIEF DESCRIPTION OF THE DRAWINGS

Various embodiments of the invention are disclosed in the following detailed description and the accompanying drawings.

FIG. 1 is a diagram showing an embodiment of a system for implementing application jumps.

FIG. 2 is a flow diagram showing an embodiment of a process for configuring jump association information.

FIG. 3 is a flow diagram showing an embodiment of a process for a user configuration of a set of jump association information corresponding to a source object.

FIG. 4 shows examples of jump association configuration user interfaces for receiving user configuration of jump association information.

FIG. 5 is a flow diagram showing an embodiment of a process for an automatic configuration of a set of jump association information corresponding to a source object.

FIG. 6 is a flow diagram showing an embodiment of a process for implementing application jumps.

FIG. 7 is a diagram showing an example presentation of representations of target apps in a jump interface.

FIG. 8 is a diagram showing an example presentation of representations of specific user interfaces of target apps in a jump interface.

FIG. 9 is an embodiment of a client device for implementing app jumps.

FIG. 10 is an embodiment of a client device for generating sets of jump association information.

FIG. 11 is an embodiment of a client device for generating sets of jump association information.

FIG. 12 is a functional diagram illustrating an embodiment of a programmed computer system for implementing app jumps.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Embodiments of implementing application jumps are described herein. In various embodiments, a software application is sometimes referred to as an “app.” In various embodiments, a “jump association” between a source object and a target app destination comprises a correspondence such that in response to a trigger with respect to a currently executing source object at a client device, the target app destination is caused to automatically be presented as an option that the user can select to switch (which is sometimes referred to as “jump”) to at the client device. Example types of a source object include a source app, a specific user interface of a source app, a function provided by a specific source app interface, a preset control with an overlapping display on a specific source app user interface, and a designated content in a source app or specific source app interface. Examples of a target app destination include the main/default interface of a target app after it is opened and a specific user interface of a target app. A set of jump association information corresponding to a source object comprises one or more target app destinations with which jump associations have been generated with the source object. In some embodiments, the set of jump association information corresponding to a source object is configurable by a user. In some embodiments, the set of jump association information corresponding to a source object is automatically configured based on an analysis of one or more user's historical app usage activity subsequent to the execution of the source object. In various embodiments, in response to an app jump interface trigger (e.g., an event or operation) with respect to a currently executing source object, the target app destinations of the previously configured and stored set of jump association information corresponding to the source object are presented in a jump interface. In response to a selection of a presented target app destination in the jump interface, an app interface associated with the selected target app destination is configured to be presented at the client device, while the previously presented source object is paused, dismissed, and/or hidden from view.

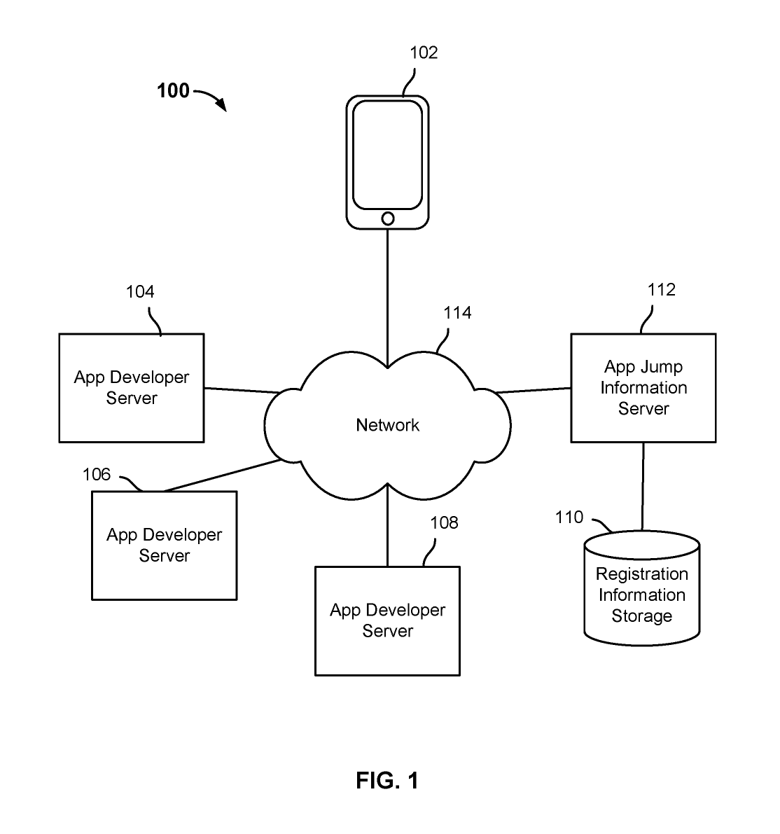

FIG. 1 is a diagram showing an embodiment of a system for implementing application jumps. As shown in the example, system 100 includes client device 102, app developer server 104, app developer server 106, app developer server 108, registration jump information storage 110, app jump information server 112, and network 114. Network 114 may comprise high-speed data networks and/or telecommunication networks. Each of client device 102, app developer server 104, app developer server 106, app developer server 108, and app jump information server 112 is configured to communicate with one another over network 114.

Client device 102 is configured to store a set of jump association information corresponding to one or more source objects. For example, source objects comprise apps, specific user interfaces of apps, designated content in apps, a preset jump trigger gesture, a user selection operation with respect to a preset control, triggering a function that is provided by a specific app interface, and a user selection corresponding to a preset key. A set of jump association information corresponding to each source object comprises one or more target app destinations, which in response to an app jump interface trigger (e.g., an event or operation) occurring with respect to the source object that is currently executing at the client device, will be presented in a user interface (which is sometimes referred to as the “jump interface”) at client device 102. In response to a user selection of a presented target app destination, a jump will be made to the target app destination at client device 102. In various embodiments, “jumping to” a target app destination from a source object comprises pausing, dismissing, and/or hiding the source object that was previously presented at client device 102 from view and switching to a presentation, launching, and/or execution of the target app destination. In various embodiments, a target app destination is jumped to by invoking the jump link information (e.g., a deep link) corresponding to the target app destination. In various embodiments, jump link information corresponding to a target app destination comprises a uniform resource identifier that can be used to link to an app interface.

In some embodiments, a set of jump association information corresponding to a source object is configured by a user. In some embodiments, a user configuration of a set of jump association information corresponding to a source object comprises client device 102 obtaining candidate target app destinations from one or more sources. The obtained candidate target app destinations are then presented at client device 102 at a jump association configuration interface. The candidate target app destinations that are selected by the user are then stored in the set of jump association information corresponding to the source object. For example, a first source of candidate target app destinations comprises app jump information server 112 that is configured to receive and store at registration information storage 110, app registration information from various app developer servers such as app developer servers 104, 106, and 108. In various embodiments, registration information associated with an app comprises an identifier/name of the app, the identifiers/names of specific user interfaces of the app, and/or jump link information corresponding to each specific user interface of the app. In some embodiments, client device 102 is configured to receive app registration information from app jump information server 112 and store such information in a first app jump information bank that is maintained locally at client device 102. For example, a second source of candidate target app destinations comprises app installation packages of apps that have already been installed at client device 102. App developers have already designated in the configuration list of an app installation package information such as the identifier/name of the app, the identifiers/names of specific user interfaces of the app, and/or jump link information corresponding to each specific user interface of the app. Therefore, a second app jump information bank can be generated based on the app information that is collected from various app installation packages and maintained locally at client device 102. For example, a third source of candidate target app destinations comprises apps that have already been installed at client device 102 but for which app developers have not provided registration information (e.g., via an app installation package). The identifiers/names and jump link information corresponding to the main/default interfaces of apps for which developers have not provided registration information and/or app installation package information can be determined through client device 102's system configuration file (or any related information). In some embodiments, a set of jump association information corresponding to a source object is automatically generated based on analyzing one or more user's historical app usage data subsequent to execution of the source object.

As will be described in further detail below, various embodiments of implementing app jumps as described herein enable efficient switching between app interfaces at a client device by enabling users to access a subsequent app interface without needing to manually exit the previous app and/or search for the subsequent app interface. Target app destinations to jump to from a source object may be customized by a user to suit his or her needs and/or may be automatically tailored for the user based on his or her historical app usage patterns.

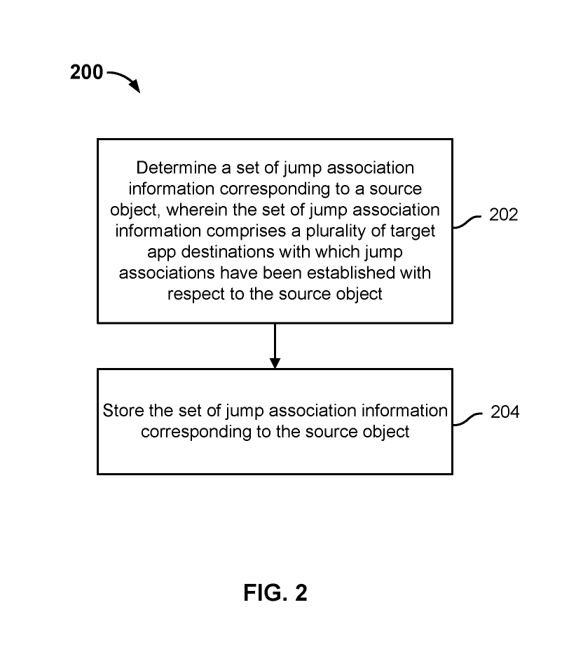

FIG. 2 is a flow diagram showing an embodiment of a process for configuring jump association information. In some embodiments, process 200 is implemented at system 100 of FIG. 1. In some embodiments, process 200 is specifically implemented at client device 102 of system 100 of FIG. 1.

At 202, a set of jump association information corresponding to a source object is determined, wherein the set of jump association information comprises a plurality of target app destinations with which jump associations have been established with respect to the source object.

In various embodiments, a “set of jump association information” corresponding to a source object comprises a set of information that identifies one or more target app destinations to which a jump can be performed from a source object that is currently executing, opened, and/or received at a client device. In some embodiments, the set of jump association information corresponding to a source object can at least be partially configured by a user. In some embodiments, the set of jump association information corresponding to a source object can be automatically generated based on historical app usage activity by the user, as will be described further below.

In various embodiments, a “source object” comprises a currently open, executing, and/or presented object at a client device from which a jump may be performed to result in the opening, execution, presentation, and/or launch of a target app destination at the client device (and with the close/pause in execution and/or dismissal of the source object). For example, a first source object type is an app that is currently open at a client device, a second source object type is a specific user interface of an app that is currently open at the client device, and a third source object type is a specific user operation that occurs with respect to an app that is currently open at the client device. In various embodiments, a “target app destination” comprises a target app, a specific user interface of a target app, and/or a target app jump link information that will be (e.g., directly or immediately) opened, executed, and/or presented at the client device subsequent to a performance of a jump from a source object. In some embodiments, “target app jump link information” or sometimes “jump link information” comprises a deep link (e.g., a uniform resource identifier (URI)) that links to a specific location (e.g., a specific user interface that is identifiable by an address) in an app (as opposed to just launching the app). The deep link can be configured to conform to preset deep link standards associated with the operating system that is running at the client device. For example, target app jump link information may also include data to be passed from the source object to the target app. In some embodiments, there are one or more types of source objects. In some embodiments, a different set of jump association information with different target app destination information may be configured for a source object depending on the type of the source object. In response to an execution of a source object type, the target app destination information, comprising one or more target app destinations, corresponding to that source object type, can be presented in a user interface for performing a jump at the client device such that the user can, potentially, select one such target app destination to which to jump. In various embodiments, for simplicity, a “user interface for performing a jump” is sometimes referred to as a “jump interface.” For example, target app destination information corresponding to a specific user operation source object can be presented at a jump interface in response to the performance of that specific user operation. In another example, target app destination information corresponding to an app source object can be presented at a jump interface in response to a user selection to open, execute, and/or present that app. In yet another example, target app destination information corresponding to a specific app interface source object can be presented at a user interface for performing a jump to open, execute, and/or present that specific app interface.

In some embodiments, if a target app destination is selected by a user from a presented jump interface, then the target app destination is immediately opened and/or executed at the client device. In some embodiments, to open and/or execute a selected target app destination, an identifier associated with the selected target app destination or the target app jump link information is passed to the operating system of the client device and the operating system (e.g., Android or iOS, for example) is configured to open (or send the corresponding link information to another app to open) the main/default interface of the target app (a main or default interface of a target app is that interface that would be presented in response to a user selection of the icon of the target app that is presented at the desktop), if a particular interface or location within the target app is not specified by the target app destination information.

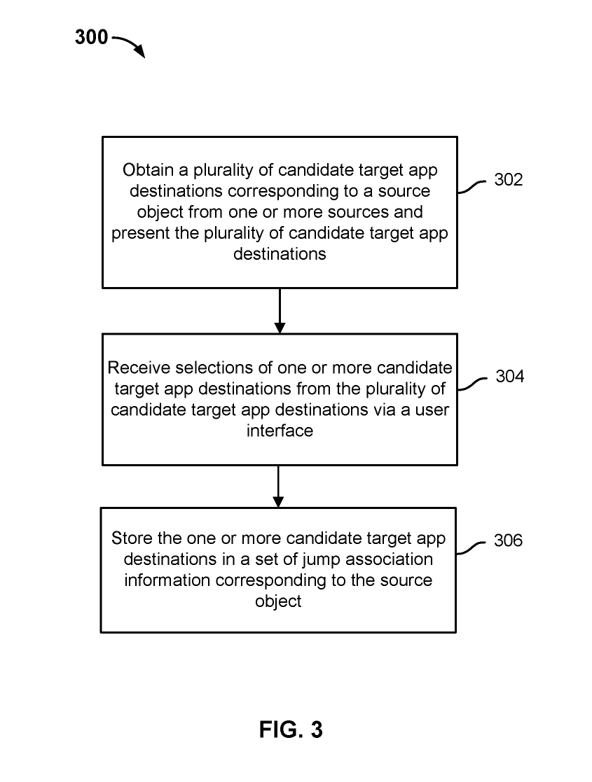

In some embodiments, the set of jump association information corresponding to a source object is configured by a user. In some embodiments, at least some of the candidate target app destinations that the user can select to add to the set of jump association information corresponding to the source object are provided by app developers (e.g., and stored at a first app jump information bank that is accessible via a cloud server). In some embodiments, at least some of the candidate target app destinations that the user can select to correspond to the source object in the set of jump association information corresponding to the source object are provided by metadata (e.g., configuration information) associated with apps that have already been installed at the client device (e.g., and stored at a second app jump information bank that is stored local to the client device). FIG. 3, below, further describes user configuration of a set of jump association information corresponding to a source object.

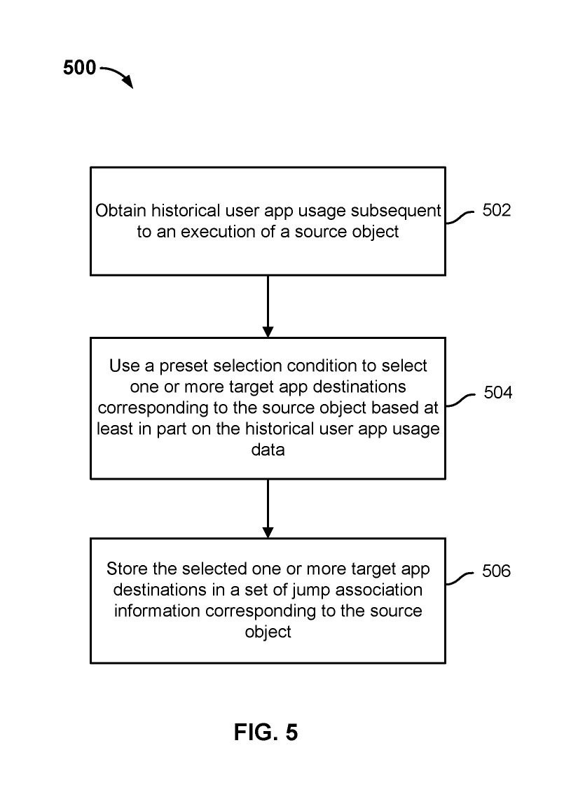

In some embodiments, the set of jump association information corresponding to a source object is automatically configured based on the user's historical app usage activity. In some embodiments, at least some of the candidate target app destinations that the user can select to correspond to the source object in the set of jump association information corresponding to the source object are provided by analyzing historical user usage of apps at the client device. FIG. 5, below, further describes automatically configuring a set of jump association information corresponding to a source object.

At 204, the set of jump association information corresponding to the source object is stored.

In this example, the stored set of jump association information corresponding to a source object is automatically presented in a jump interface at the client device in response to a user selection of an app jump interface trigger with respect to the source object. The user can then select one of the target app destinations from the set of jump association information corresponding to the source object that is presented at the jump interface to cause (e.g., the operating system and/or another designated app of) the client device to perform a jump and result in the execution, launch, presentation, and/or opening of the selected target app destination at the client device.

FIG. 3 is a flow diagram showing an embodiment of a process for a user configuration of a set of jump association information corresponding to a source object. In some embodiments, process 300 is implemented at system 100 of FIG. 1. In some embodiments, process 300 is specifically implemented at client device 102 of system 100 of FIG. 1. In some embodiments, step 202 of process 200 is implemented using a process such as process 300.

At 302, a plurality of candidate target app destinations corresponding to a source object is obtained from one or more sources and presented at a user interface.

In some embodiments, in the user configuration of a set of jump association information corresponding to a source object, candidate target app destinations corresponding to the source object are obtained from one or more sources (e.g., jump information banks) and presented at a jump association configuration user interface. The user may then select one or more candidate target app destinations to include in the set of jump association information corresponding to the source object. Each target app destination in the set of jump association information corresponding to the source object has established a jump association with respect to the source object. Therefore, in process 300, the user is provided with the opportunity of customizing jump association information corresponding to a source object based on his or her personal use habits and preferences.

In some embodiments, a first type of source from which candidate target app destinations can be obtained is an (e.g., remote) app information bank that includes information that is prepopulated by app developers. In some embodiments, a second type of source from which candidate target app destinations can be obtained is the client device itself. These two types of sources are further described below:

1) Source 1: App Information Bank(s)

The app jump information bank may be a first app jump information bank that is generated at the client device based on information that is obtained from a (e.g., cloud) server that provides a jump registration service or it could be a second app jump information bank that is generated at the client device at which app jumps are to be performed from the app installation process at the client device.

In some embodiments, the first app jump information bank may be generated based on one or more app developers performing a registration operation at a server. In various embodiments, executing a registration operation at the server comprises uploading app interface-related information, such as the interface names and/or jump link (e.g., deep link) information, that can be directly used by another app or an operating system to jump to one or more specific user interfaces of that app. The server stores such registration information and provides the registration information to one or more client devices. For example, the server can periodically send all stored registration information to one or more client devices or send only a newly uploaded portion of the stored registration information to one or more client devices upon detecting a new upload. In another example, the server can send a requested portion of the stored registration information to a requesting client device. The client device generates a first app jump information bank according to registration information received from the server. For example, the server may comprise a cloud platform for reasons of data storage safety and stability. Registration of app information can be implemented in a unified manner on the server so that registration information may be subject to centralized management and maintenance.

In some embodiments, the second app jump information bank may be generated by the client device based on one or more app developers designating in the configuration list of an app installation package the interface names and/or jump link (e.g., deep link) information that can be directly used by another app or an operating system to jump to one or more specific user interfaces of that app. Taking the example of an Android operating system-based client device, the configuration list may refer to the AndroidManifest.xml file. When an app package is installed on a client device at which app jumps are to be performed, interface names and/or jump link (e.g., deep link) information of the apps in the package may be looked up by the client device in its configuration list and the found information may be used to add an item corresponding to this app to the second app jump information bank. By employing such an approach, one does not need to set up a public jump registration server such as is needed for the first app jump information bank because the registration management is carried out locally, entirely by the client device. This approach can reduce interactions between the client and the server to thereby increase the information to add to a jump information bank and reduce reliance on a network connection.

The first or second app jump information bank that is described above generally comprises a list of items. For example, each item corresponds to information related to an app interface that can be directly opened by (e.g., jumped to from) another app. To take a mobile app as an example, when the app developer registers information with the server or edits the configuration list, the app developer ensures that the app package includes app interfaces that can be directly opened by other apps using deep links. For example, for an Android operating system-based client device, deep link is the schema for opening an app interface (activity). For example, the deep link schema for an app payment interface is: appName://payment. Other apps can directly open the payment interface for this app via this deep link schema. Using a navigation app as an example, after the registration operation of the navigation app is performed by the developer of the app, example items in the corresponding app jump information bank are as shown in Table 1, below:

TABLE 1
Navigation app items in an app jump information bank

| Name of App | Name of Interface | Deep Link Schema |
|---|---|---|
| Navigation | Public transport | avi://bus |
| | navigation | |
| Navigation | Nearby cuisine | avi://aroundfood |
| . . . | . . . | . . . |

In actual implementation, each item in a table such as Table 1 could also contain package name information and/or other information. For example, the package name corresponding to the navigation app is: com.sample.avi. The package name and deep link information uniquely define the jump link for an app interface, in some embodiments.

In the example described above, the deep link information is the schema for an app interface (activity). In an actual application, deep link information may have diverse forms, especially for different operating systems. For example, for a web page-based application, the deep link information can be the URL information for a page.

2) Source 2: Apps that have Already been Installed but have not Yet Executed a Registration Operation at the Client Device

The candidate target app destinations may comprise the main/default interfaces of apps that are installed on a client device at which app jumps are to be performed but whose app developers have not yet executed a registration operation at a server. As such, in some embodiments, a client device's system configuration file (or any related information) is used to obtain the identifiers and jump link information (e.g., the launch link information in an Android operating system) of the main/default interfaces of apps that have been installed at the client device but for which registration operations have not yet been performed. For example, the main/default interface of an app comprises the interface that is executed when the app's icon that is presented at the desktop is selected by a user. By searching for apps that have been installed at the client device but for which registration operations have not yet been performed, there is no need for the app developer to supply a registration information at the server or locally and therefore simplifies the overall system design, reduces requirements for the app provider, and lowers the complexity of implementation.

The above described sources of candidate target app destinations are merely examples and other sources may be used in actual implementation. In actual implementation, it may also be possible to obtain candidate target app destinations from one or more sources, including, but not limited to, Source 1 and Source 2, as described above.

At 304, selections of one or more candidate target app destinations from the plurality of candidate target app destinations are received via the user interface.

At 306, the one or more candidate target app destinations are stored in a set of jump association information corresponding to the source object.

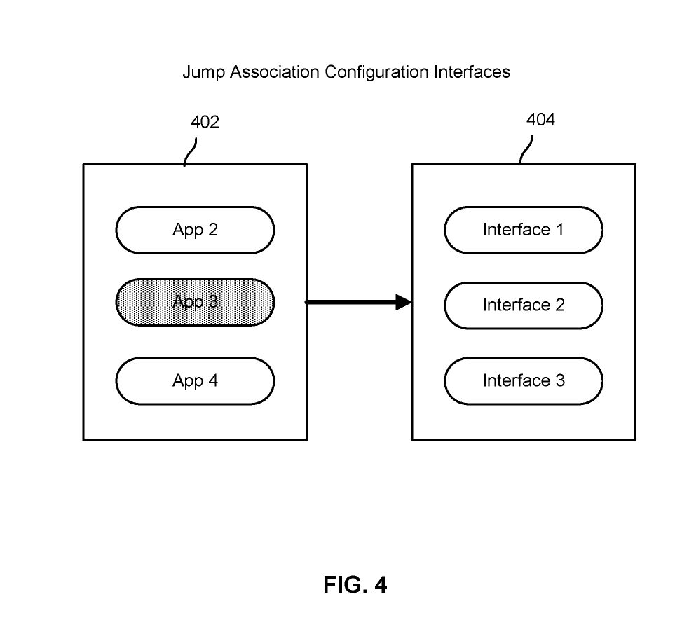

In some embodiments, the obtained candidate target app destinations can be selected by a user in a jump association configuration user interface in a multiple step process. For example, candidate target app destinations that comprise target apps are presented first. Then, after a user selection of one of such target apps is received, one or more specific user interfaces of the target apps are presented at an updated jump association configuration user interface. Then a user selection of one or more of the specific user interfaces of the target apps is received to establish jump associations between the selected specific user interfaces of the target apps with the source object. FIG. 4 shows examples of jump association configuration user interfaces for receiving user configuration of jump association information. For the source object of Interface 1 of App 1 (not shown in the diagram), jump association configuration interface 402 displays the list of candidate target apps for which jump associations can be established with source object App 1 Interface 1. Jump association configuration interface 402 shows candidate target apps of App2, App3, and App4. After the user performs a selection operation on the candidate target app, App 3, updated jump association configuration interface 404 includes candidate target app interfaces of Interface 1, Interface 2, and Interface 3, which are all specific user interfaces of App 3.

After the candidate target app destinations are displayed in the jump association configuration interface, the user's selection(s) of the candidate target app destinations are stored in a set of jump association information for the source object. If a candidate target app destination selected by the user is a target app destination provided by the first or second app jump information bank, then the selected target app destination and its corresponding jump link information that are included in the app jump information bank are used to determine the appropriate jump association information. If a candidate target app destination selected by the user is a main interface of an app installed at the client device and for which a registration operation has not yet been performed, the jump link information for the main interface is acquired from the configuration file, stored locally at the client device, for that app, and the appropriate jump association information corresponding to that target app destination is generated using the obtained main interface and its jump link information.

Further applying the example of FIG. 4, if the user selects Interface 1 and Interface 2 in updated jump association configuration interface 404 (that is displayed in response to a user selection of App 3 in jump association configuration interface 402), the client device generates the jump association information between source object App 1 Interface 1 and each of App 3 Interface 1 and App 3 Interface 2, as is shown in Table 2, below. Link1 and link2 are respective deep link information corresponding to Interface 1 and Interface 2 of App 3.

TABLE 2
Jump association information corresponding to source object App 1
Interface 1

| | Name of Target | Name of Target | |
|---|---|---|---|
| Source Object | App | App Interface | Deep link |
| App 1 Interface 1 | App 3 | Interface 1 | link1 |
| App 1 Interface 1 | App 3 | Interface 2 | link2 |
| | . . . | . . . | . . . |

While the example of FIG. 4 describes configuring jump association information associated with an app interface type of a source object, jump association information can be similarly configured for other types of source objects (e.g., a source app, a function provided by a specific source app interface, a preset control with an overlapping display on a specific source app user interface, and a designated content in a source app or specific source user app interface) and will not be described further herein.

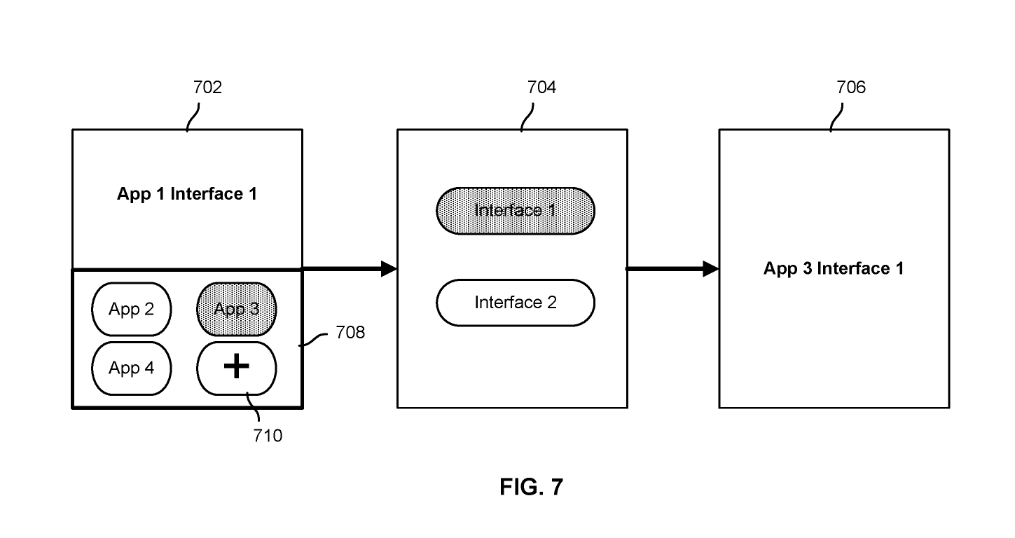

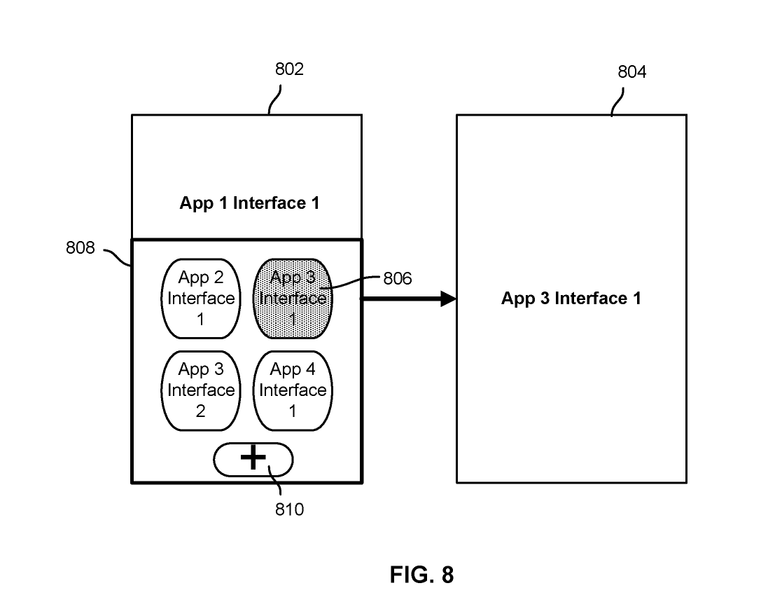

In some embodiments, a user configuration of a set of jump association information corresponding to a source object such as process 300 of FIG. 3 can be triggered in response to a user selection of a configuration control. In some embodiments, the configuration control corresponding to a source object is presented in a unified jump association configuration app for a user-selected source object. In some embodiments, the configuration control is embedded in a jump interface that is displayed for a user-selected source object. In any event, once the configuration control is selected, the jump association configuration interface to the source object can be presented. FIGS. 7 and 8, which will be described in further detail below, each shows an example jump interface in which a configuration control is shown as a “+” symbol.

FIG. 5 is a flow diagram showing an embodiment of a process for an automatic configuration of a set of jump association information corresponding to a source object. In some embodiments, process 500 is implemented at system 100 of FIG. 1. In some embodiments, process 500 is specifically implemented at client device 102 of system 100 of FIG. 1. In some embodiments, step 202 of process 200 is implemented using process 500.

In contrast to process 300 of FIG. 3, process 500 automatically analyzes historical app usage by the user subsequent to an execution of the source object to then determine one or more target app destinations to be automatically included in the set of jump association information corresponding to the source object, without user intervention.

At 502, historical user app usage data subsequent to an execution of a source object is obtained.

The historical data of the user of other apps other than the app related to the source object after the execution of a particular source object is obtained. For example, the historical data is stored at the client device and/or at a server (which had previously received the data from the client device). In some embodiments, the historical data may be associated with the specific user for which a set of jump association information corresponding to the source object is to be established. In some embodiments, the historical data may be associated with multiple users for which a set of jump association information corresponding to the source object is to be established.

As described above, different types of source objects may include an app that is currently open, a specific app interface of an app that is currently open, a user operation with respect to a designated content of an app that is currently open, or a specific user operation that occurs with respect to an app that is currently open. As such, execution of the different types of source objects may include using a specific app interface, using an app, performing a user selection of a designated content of an app, or executing a specific user operation that occurs with respect to an app that is currently open.

The historical data may be generated by a log application, a system event log utility, or the like, that monitors and records how a user uses apps following execution of an app, a specific app interface, a designated content, or a specific user operation that occurs with respect to an app that is currently open/executing at the client device may be monitored, including, for example, but not limited to: which apps were activated, which app interfaces were accessed, the length of time spent at each interface, the operations that were executed at each app interface, and so forth.

At 504, a preset selection condition is used to select one or more target app destinations corresponding to the source object based at least in part on the historical user app usage data.

The historical data of user app usage is used to represent the user's intent subsequent to the execution of a source object, including the other apps and/or specific user interfaces of other apps to which the user had manually opened (jumped to) after executing the source object. Therefore, these other apps are potential target app destinations with which jump associations may be established with the source object. A set of predetermined selection criteria is applied to the historical data of user app usage to determine one or more target app destinations corresponding to the source object.

In some embodiments, a preset selection condition for selecting a jump destination (e.g., an app or a specific user interface of the app) from the historical data as a target app destination is if the number of times that the jump destination is used following execution of the source object is greater than a preset threshold value or the use frequency of the jump destination following execution of the source object is greater than a preset threshold value. In some embodiments, a preset selection condition is that the use time for a jump destination is greater than a preset threshold length.

At 506, the selected one or more target app destinations are stored in a set of jump association information corresponding to the source object.

In some embodiments, the jump link information corresponding to at least some of the target app destinations that are determined at step 504 is obtained from the configuration information of the app associated with the target app destinations. For example, the configuration of the app may have been included in the app installation package associated with the app. The jump link information of the target app destinations is included in the set of jump association information corresponding to the source object that is stored.

In actual implementation, one or a combination of both of a user configuration of a set of jump association information corresponding to the source object such as described in process 300 of FIG. 3 and an automatic configuration of a set of jump association information corresponding to the source object as described in process 500 of FIG. 5 may be used to provide the user a great abundance of jump options. For example, a source object for which user configuration has not been performed may receive a set of jump association information based on an automatic configuration. Ultimately, the target app destinations that are presented to a user who triggers a jump interface for a source object may be determined from the set of jump association information corresponding to the source object that has been generated from either or both of user configuration and automatic configuration.

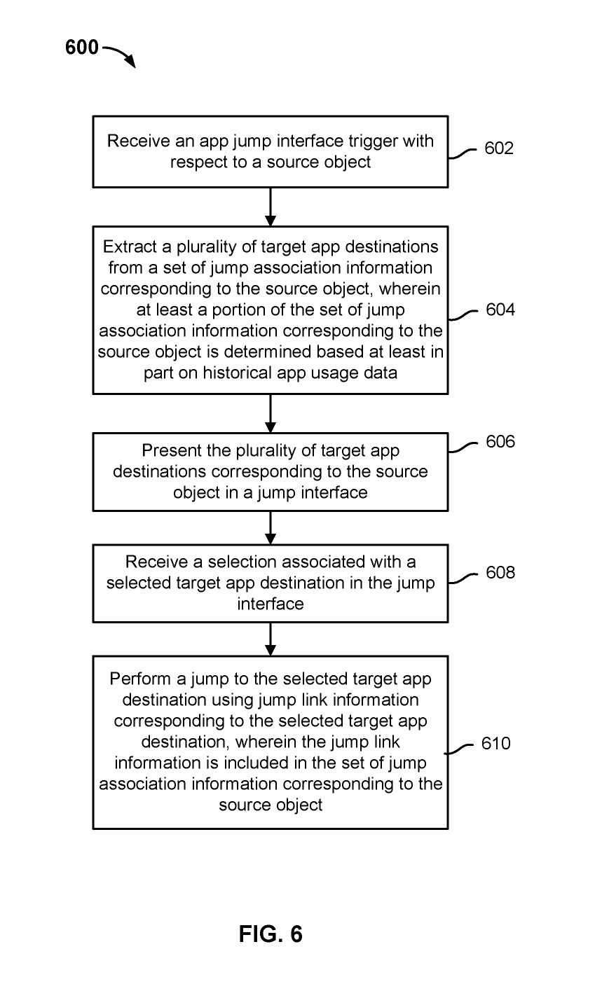

FIG. 6 is a flow diagram showing an embodiment of a process for implementing application jumps.

At 602, an app jump interface trigger is received with respect to a source object.

After the user starts an app at the client device, the user will interact with the app by, for example, swiping an app interface and clicking a displayed control on an interface of the app. In various embodiments, one or more particular user interactions or operations or events with respect to the open app are each set as an app jump interface trigger that causes a jump interface that includes a set of jump association information corresponding to a source object associated with the trigger to be presented at the client device.

Some example app jump interface triggers are described below:

1) The app jump interface trigger is an operation directed at designated content of the app interface. In this type of app jump interface trigger, the source object comprises the designated content of the app interface. For example, the app jump interface trigger is a user selection operation directed at specific position and/or navigation information displayed in the app interface (e.g., a click or touch of an icon representing a position in a map). In such a situation, a jump interface may be displayed to help the user jump to a target app destination that comprises a navigation app or other associated app. In a second example, the app jump interface trigger is a user selection (e.g., a click or touch) operation directed at product information displayed in the app interface. In such a situation, a jump interface may be displayed to help the user jump to a target app destination that comprises a shopping app or other associated app.

2) The app jump interface trigger is an operation of selecting on a specific user interface of the app. In this type of app jump interface trigger, the source object comprises the specific user interface of the app. For example, the app jump interface trigger is an operation of selecting to view a payment interface. In such a situation, a jump interface may be displayed to help the user select from target app destinations that comprise multiple payment apps.

3) The app jump interface trigger is an operation of triggering a function provided by an app interface. In this type of app jump interface trigger, the source object comprises the user operation to trigger the function. For example, the app jump interface trigger is a user selection (e.g., a click or touch) on the “Edit” button in a photo browsing interface. In such a situation, a jump interface may be displayed to help the user select from target app destinations that comprise multiple editing apps.

4) The app jump interface trigger is consistent with a preset jump trigger gesture. In this type of app jump interface trigger, the source object comprises the app interface that is open as the preset jump trigger gesture is performed. The preset jump trigger gesture could be, for example: a double-clicking the app interface, a triple-clicking the app interface, up-swiping the app interface, and down-swiping the app interface. If an app jump interface trigger consistent with a preset jump trigger gesture is received, then the target app destinations included in the set of jump association information corresponding to the opened app interface are presented in a jump interface.

5) The app jump interface trigger is a user selection operation corresponding to a preset control with an overlapping display on the app interface. In this type of app jump interface trigger, the source object comprises the preset control with an overlapping display on the app interface. For example, a preset control may be displayed in an overlapping way in the app interface. If a trigger operation by the user is received for this control, this will indicate that the user wishes to execute an app jump operation. If an app jump interface trigger that is the preset control is received, then the target app destinations included in the set of jump association information corresponding to the opened app interface are presented in a jump interface.

6) The app jump interface trigger is a user selection operation for a preset key of a client device. In this type of app jump interface trigger, the source object comprises the app interface that is open as the preset key of the client device is selected. The button could be a physical or a soft button preset on the client device. If an app jump interface trigger that is the preset key selection is received, then the target app destinations included in the set of jump association information corresponding to the opened app interface are presented in a jump interface.

At 604, a plurality of target app destinations from a set of jump association information corresponding to the source object is extracted, wherein at least a portion of the set of jump association information corresponding to the source object is determined based at least in part on historical app usage data.

Once the app jump interface trigger is activated for a source object, then the target app destinations that are included in the stored set of jump association information corresponding to the source object are extracted so that they can be presented at a jump interface. For example, the set of jump association information corresponding to the source object is determined using one or more processes such as process 300 of FIG. 3 or process 500 of FIG. 5.

At 606, the plurality of target app destinations corresponding to the source object is presented in a jump interface.

As described above, the jump interface comprises a user interface through which a user can select a target app destination to jump to from the source object. In some embodiments, the jump interface is presented in a manner that overlays or floats over the currently open app interface. In some embodiments, the jump interface is presented semi-transparently over the currently open app interface. In some embodiments, the jump interface is presented in an area of the screen area of the client device that does not overlap with the currently open app interface.

To avoid presenting the jump interface in response to a user's inadvertent selection of an app jump interface trigger with respect to a source object, in some embodiments, in response to a selection of an app jump interface trigger, a prompt to open the jump interface is presented at the client device. The prompt includes a control (e.g., a button), which if selected by the user and therefore indicates that the user did intend to view the jump interface, will cause the jump interface to be presented. Otherwise, if a preset time interval elapses after the control is presented and the control is not selected, then the prompt will be dismissed and the jump interface will not be presented. For example, a prompt may comprise a pop-up window (e.g., a modal window that is displayed in a manner that overlays the current app that is displayed at the client device) and the control may comprise an icon associated with app jump (e.g., an arrow). The usage of the prompt to confirm the presentation of the jump interface can avoid the possibility of presenting a jump interface when the user had not intentionally triggered the presentation of the jump interface.

In some embodiments, the set of jump association information that is presented at a jump interface depends on the type of the source object with which the app jump interface triggered was performed. For example, if the app jump interface trigger was performed with respect to designated content of the app interface or comprises an operation of jumping to a designated interface of the app, then the jump association information that was generated for the designated content or the operation of jumping to a designated interface of the app, respectively, may be displayed. In another example, if the app jump interface trigger is consistent with a preset jump trigger gesture, then the jump association information that was generated for the specific app interface that is currently presented or the app to which the currently displayed interface is associated may be displayed.

The target app destinations from the set of jump association information corresponding to the source object may be presented in the jump interface in various ways. In some embodiments, the target app destinations are presented as the names of the target app destinations and/or images or icons associated with the target app destinations. For example, when the target app destination is a target app, then an icon associated with the target app may be presented. In another example, when the target app destination comprises a target app interface, a thumbnail associated with the target app interface may be presented.

In some embodiments, the presentation of some target app destinations of a set of jump association information corresponding to the source object is prioritized in the jump interface. Then, target app destinations that are prioritized are displayed in the jump interface earlier and/or more conspicuously than target app destinations that are not prioritized. In some embodiments, historical jump data is used to determine which target app destinations to prioritize in the jump interface. In some embodiments, historical jump data is generated by recording (e.g., at the client device) each historical user selection on each target app destination. After a set of jump association information corresponding to a source object is obtained and each target app destination is extracted from the set of jump association information, a jump correlation level between each target app destination and the source object is determined based at least in part on the historical jump data associated with the target app destination. For example, the jump correlation level is determined based on a number of historical user selections associated with the target app destination and/or a frequency of historical user selections associated with the target app destination. In some embodiments, a target app destination that is associated with a jump correlation level that is either associated with a top preset number of jump correlation levels or meets a preset requirement (e.g., a threshold number of historical user selections and/or a threshold frequency of historical user selections) is presented in a more prioritized manner in the jump interface. For example, assume that the jump interface can present five target app destinations. Thus, the five target app destinations with the highest jump correlation levels could be selected and given priority display within the jump interface. Then the target app destinations with the next five highest jump correlation levels may be loaded and displayed when the user executes a similar page-turning operation within the jump interface. In another example, assume that the jump interface can present all target app destinations in a list format in the jump interface. In such a scenario, the target app destinations that are associated with the highest jump correlation levels are presented earlier in the list than target app destinations with lower jump correlation levels in the jump interface.

At 608, a selection associated with a selected target app destination in the jump interface is received.

At 610, a jump to the selected target app destination is performed using jump link information corresponding to the selected target app destination, wherein the jump link information is included in the set of jump association information corresponding to the source object.

In response to a user selection of a representation (e.g., a name, an image, and/or a thumbnail) of a target app destination, the currently executing/presented app associated with the source object is paused and hidden and the selected target app destination is jumped to (e.g., launched, opened, presented, and/or executed) at the client device (e.g., by an operating system of the client device and/or using the jump link information associated with the selected target app destination). By allowing a user to customize sets of jump association information and/or customizing sets of jump association information for a user, the user is able to jump from source objects to a related target app destination quickly and without needing to manually exit one app and then search for a next desired app or app interface.

The following describes the consequences of a user selection to jump to each of two example types of target app destinations:

(I) The Target App Destination is a Target App

Because certain target apps may only have one app interface, in some embodiments, after a user selection is received with a target app destination that comprises a target app is received, it is first determined whether the set of jump association information comprises jump link information for just one app interface of the target app or for two or more app interfaces of the selected target app. After it is determined that the set of jump association information comprises jump link information for just one app interface of the target app or for two or more app interfaces of the selected target app, it is determined which specific user interface of the target app to which the jump will be performed. In various embodiments, the jump link information corresponding to a target app destination comprising an entire target app in a set of jump association information comprises jump link information (e.g., a deep link) to each of at least a subset of specific user interfaces of the target app.

In the event that the set of jump association information comprises jump link information for two or more app interfaces of the target app, a representation (e.g., an image or thumbnail) associated with each such interface is presented in response to the user selection of the target app. After a user selection is received with respect to a presented representation associated with a specific user interface of the selected target app, the jump link information corresponding to the selected target app interface is used to jump to that interface. For example, an invocation operation is called and the selected target app interface is executed using the jump link information corresponding to that selected target app interface.

In the event that the set of jump association information comprises jump link information for only one interface of the target app, the jump link information corresponding to the only target app interface is used to jump to that interface.

FIG. 7 is a diagram showing an example presentation of representations of target apps in a jump interface. As shown in the example of FIG. 7, in display screen 702 at a client device, Interface 1 of App 1 is the source object that is currently being executed and/or presented. In response to an app jump interface trigger with respect to source object Interface 1 of App 1, jump interface 708 is presented. Jump interface 708 includes representations of App 2, App 3, and App 4 and also configuration control 710, which is shown as a button with a “+” symbol. As described above, a configuration control such as configuration control 710, once selected by a user, enables the user to customize the target app destinations associated with a source object at a jump association configuration interface. The use of the configuration control enables an efficient and simple entry point for the user to configure target app destinations for a given source object. In the example of FIG. 7, in response to a user selection of the representation of App 3, display screen 704 is presented at the client device. In display screen 704, the representations of two interfaces of App 3 (e.g., as determined from the jump link information corresponding to App 3 in the set of jump association information corresponding to source object Interface 1 of App 1) are presented. Then, in response to a user selection of the representation of Interface 1, the Interface 1 of App 3 is jumped to, as is shown in display screen 706 at the client device.

(II) The Target App Destination is a Specific User Interface of a Target App

Where the target app destination is a specific user interface of a target app as opposed to the target app (as described above in scenario (I)), the jump link information (e.g., deep link information) corresponding to the selected specific user interface of a target app is used to directly jump to the specific user interface of a target app.

FIG. 8 is a diagram showing an example presentation of representations of specific user interfaces of target apps in a jump interface. As shown in the example of FIG. 8, in display screen 802 at a client device, Interface 1 of App 1 is the source object that is currently being executed and/or presented. In response to an app jump interface trigger with respect to source object Interface 1 of App 1, jump interface 808 is presented. Jump interface 808 includes representations of App 2 Interface 1, App 3 Interface 1, App 3 Interface 2, and App 4 Interface 1 and also configuration control 810, which is shown as a button with a “+” symbol. As described above, a configuration control such as configuration control 810, once selected by a user, enables the user to customize the target app destinations associated with a source object at a jump association configuration interface. In the example of FIG. 8, in response to a user selection of the representation of App 3 Interface 1 at 806, Interface 1 of App 3 at 806 is jumped to, as is shown in display screen 804 at the client device.

In some embodiments, where the user does not make any selection of any of the target app destinations that are presented in a jump interface after a predetermined interval of time has elapsed since the jump interface was presented, the jump interface is automatically hidden from view at the client device as it is assumed that the user does not desire to jump to a different app interface. For example, after the presentation of the jump interface is triggered, the client device may monitor the length of time that has elapsed since the jump interface has been presented. When the elapsed time exceeds a predetermined interval of time and a user selection has not been received with respect to any of the target app destinations that are presented in the jump interface, then the jump interface is automatically closed and hidden from view, so that the user does not need to manually dismiss the jump interface in order to continue browsing the currently presented app interface.

Process 600 as described above presents techniques for displaying previously configured target app destinations corresponding to a source object in a manner that provides efficient switching between apps, improved user experiences, and effective safeguards against inadvertently jumping to a different app interface.

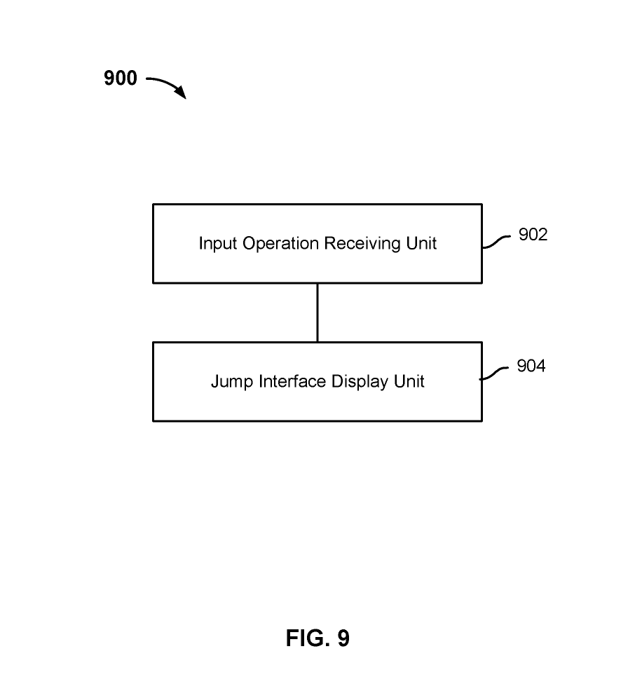

FIG. 9 is an embodiment of a client device for implementing app jumps. In the example, client device 900 comprises input operation receiving unit 902 and jump interface display unit 904.

The units and sub-units can be implemented as software components executing on one or more processors, as hardware such as programmable logic devices, and/or Application Specific Integrated Circuits designed elements can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The units and sub-units may be implemented on a single device or distributed across multiple devices.

Input operation receiving unit 902 is configured to receive an app jump interface trigger with respect to a source object. Jump interface display unit 904 is configured to present a jump interface that comprises (e.g., representations of) target app destinations that are included in a stored set of jump association information corresponding to the source object.

In some embodiments, jump interface display unit 904 comprises:

A prompt control display sub-unit that is configured to display (e.g., in a manner that overlays the app that is currently presented at the client device) a prompt associated with presenting the jump interface.

A user selection operation receiving sub-unit that is configured to receive a user selection with respect to the control of the prompt. In various embodiments, the control comprises a button that confirms the user's intention in viewing the jump interface.

An interface display executing sub-unit that is configured to present the jump interface in the event that the user selection operation receiving sub-unit had received a user selection.

In some embodiments, client device 900 further comprises:

An interface display canceling unit that is configured to automatically dismiss the presentation of the jump interface if a user selection with respect to any of the target app destinations is not received within a predetermined threshold length of time.

In some embodiments, client device 900 further comprises:

A jump destination selection unit that is configured to receive a user selection for a target app destination in a presented jump interface.

A target interface jumping unit that is configured to use the selected target app destination to determine the appropriate target app interface to which to jump.

In some embodiments, the target app destinations of the jump interface display unit comprise target apps.

The target interface jumping unit comprising:

A target interface display sub-unit that is configured to present the target interfaces of the selected target app, where the target interfaces are identified based on their jump link information being present in the set of jump association information.

A target interface selecting sub-unit that is configured to receive a user selection operation for a specific user interface corresponding to the selected target app.

A target interface jumping unit that is configured to use the jump link information included in the set of jump association information and corresponding to the selected interface of the selected target app to jump to that interface.

In some embodiments, the target interface jumping unit further comprises:

A target interface quantity assessing sub-unit that is configured to determine whether the set of jump association information comprises jump link information for just one app interface of the selected target app or for two or more app interfaces of the selected target app. In the event that the set of jump association information comprises jump link information for two or more app interfaces of the target app, the target interface display sub-unit is triggered. The target interface display sub-unit is configured to present a representation (e.g., an image or thumbnail) associated with each such interface in response to the user selection of the target app. In the event that the set of jump association information comprises jump link information for only one interface of the target app, a target interface direct display sub-unit is triggered. The target interface direct display sub-unit is configured to use the jump link information corresponding to the only target app interface to jump to that single interface.

In some embodiments, the target app destinations of the jump interface display unit comprise target interfaces.

The target interface jumping unit is configured to use the jump link information corresponding to the selected target interface to jump to that interface.

In some embodiments, client device 900 further comprises:

A smart recommending unit that is configured to generate a set of jump association information based on historical data on one or more user's usage of other apps after executing the source object.

The smart recommending unit comprising:

A historical data acquiring sub-unit that is configured to obtain historical data regarding the use of other apps following the use of a source object.

A target interface acquiring sub-unit that is configured to apply a set of selection conditions or a model to the historical data to select target app destinations.

A jump association generating sub-unit that is configured to use the selected target app destinations and their respective jump link information for generating jump association information for the source object.

In some embodiments, client device 900 further comprises:

A self-defined configuration unit that is configured to generate a set of jump association information corresponding to a source object based on the candidate target app destinations that are selected by a user.

The self-defined configuration unit comprising:

A configuration interface display sub-unit that is configured to present a jump association configuration interface. The jump association configuration interface includes candidate target app destinations that a user can select to establish a jump association with the source object.

A candidate interface selecting sub-unit that is configured to receive one or more user selection operations with respect to candidate target app destinations in the jump association configuration interface.

A jump association generating sub-unit that is configured to use the selected candidate target app destinations and their respective jump link information to generate a set of jump association information for the source object.

In some embodiments, the candidate target app destinations displayed by the configuration interface display sub-unit comprise app interfaces that are included in app jump information banks that are pre-generated by registration operations.

The jump association generating sub-unit is configured to use the selected candidate target app destinations and the jump link information included in the app jump information banks and corresponding to the selected candidate target app destinations to generate the jump association information.

The candidate target app destinations displayed by a jump association configuration interface display sub-unit comprise the main interfaces of apps that are already installed on the host device and that have not executed a registration operation.

The jump association generating sub-unit is configured to use the main interfaces and the jump link information of the main interfaces acquired from the configuration information of the apps that have not executed a registration operation to generate the jump association information.

In some embodiments, the jump interface display unit comprises:

A jump destination extracting sub-unit that is configured to extract jump destinations from the set of jump association information corresponding to the source object.

A correlation computing sub-unit that is configured to use the historical jump data recorded by the client device to compute jump correlation levels between the source object and each candidate target app destination.

A jump destination display sub-unit that is configured to prioritize the display of target app destinations whose jump correlation levels satisfy a preset requirement.

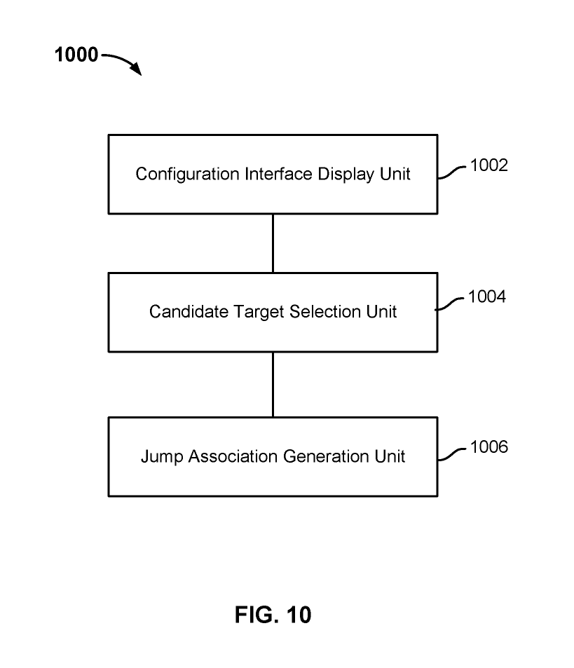

FIG. 10 is an embodiment of a client device for generating sets of jump association information. In the example, client device 1000 comprises configuration interface display unit 1002, candidate target selection unit 1004, and jump association generation unit 1006.

Configuration interface display unit 1002 is configured to display a jump association configuration interface. The jump association configuration interface comprises candidate target app destinations that a user can select to establish a jump association with a particular source object.

Candidate target selection unit 1004 is configured to receive a user selection operation for a candidate target app destination.

Jump association generation unit 1006 is configured to use the selected candidate target app destinations to generate a set of jump association information for the source object.

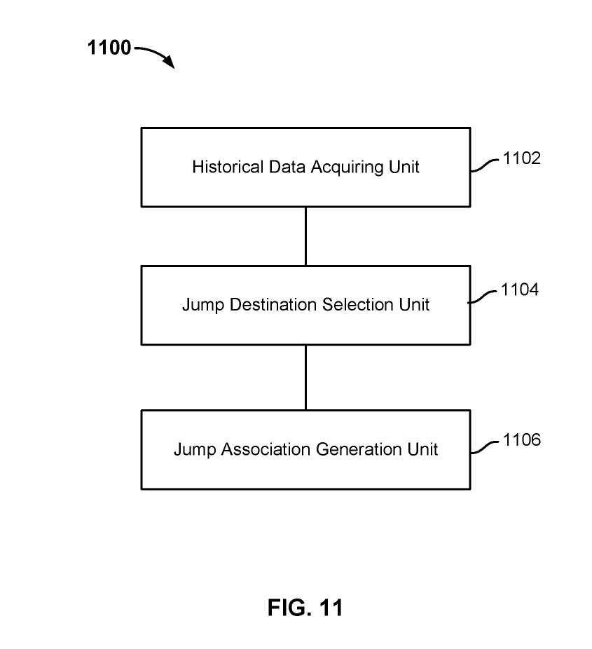

FIG. 11 is an embodiment of a client device for generating sets of jump association information. In the example, client device 1100 comprises historical data acquiring unit 1102, jump destination selection unit 1104, and jump association generation unit 1106.

Historical data acquiring unit 1102 is configured to acquire historical data on the use by one or more users of other apps following the use of a particular source object.

Jump destination selection unit 1104 is configured to apply a set of conditions or a model to the historical data to select target app destinations.

Jump association generation unit 1106 is configured to use the selected target app destinations to generate a set of jump association information for the source object.

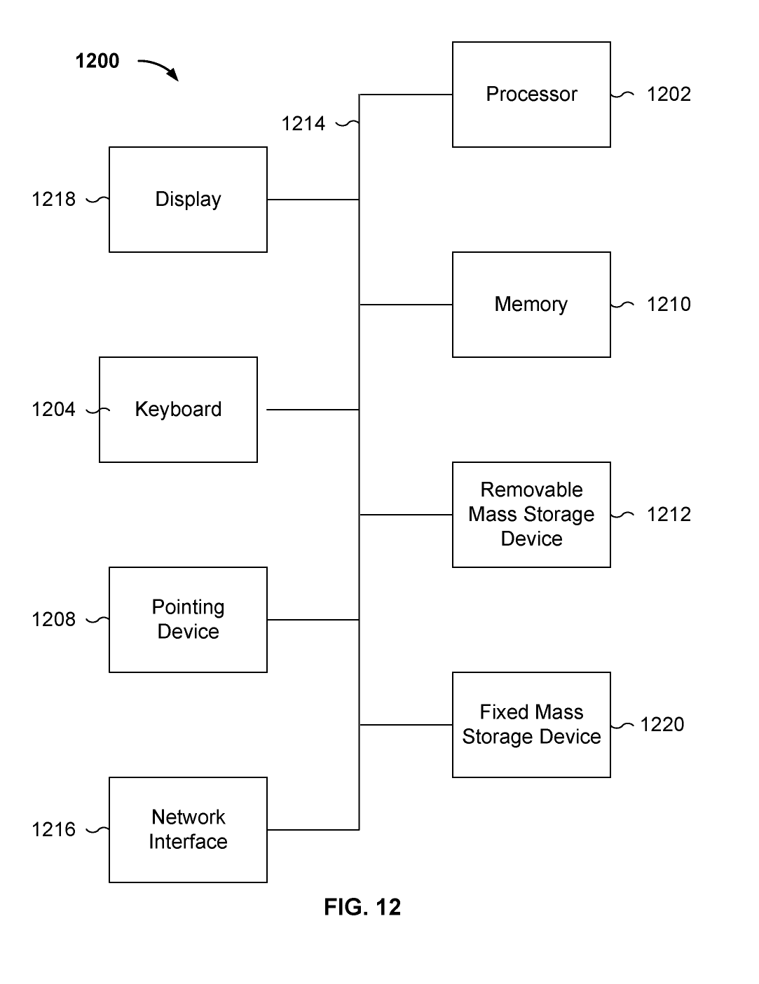

FIG. 12 is a functional diagram illustrating an embodiment of a programmed computer system for implementing app jumps. As will be apparent, other computer system architectures and configurations can be used to implement app jumps. Computer system 1200, which includes various subsystems as described below, includes at least one microprocessor subsystem (also referred to as a processor or a central processing unit (CPU)) 1202. For example, processor 1202 can be implemented by a single-chip processor or by multiple processors. In some embodiments, processor 1202 is a general purpose digital processor that controls the operation of the computer system 1200. Using instructions retrieved from memory 1210, the processor 1202 controls the reception and manipulation of input data, and the output and display of data on output devices (e.g., display 1218).

Processor 1202 is coupled bi-directionally with memory 1210, which can include a first primary storage area, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 1202. Also as is well known in the art, primary storage typically includes basic operating instructions, program code, data, and objects used by the processor 1202 to perform its functions (e.g., programmed instructions). For example, memory 1210 can include any suitable computer readable storage media, described below, depending on whether, for example, data access needs to be bi-directional or uni-directional. For example, processor 1202 can also directly and very rapidly retrieve and store frequently needed data in a cache memory (not shown).

A removable mass storage device 1212 provides additional data storage capacity for the computer system 1200 and is coupled either bi-directionally (read/write) or uni-directionally (read only) to processor 1202. For example, storage 1212 can also include computer readable media such as magnetic tape, flash memory, PC-CARDS, portable mass storage devices, holographic storage devices, and other storage devices. A fixed mass storage 1220 can also, for example, provide additional data storage capacity. The most common example of fixed mass storage 1220 is a hard disk drive. Mass storages 1212, 1220 generally store additional programming instructions, data, and the like that typically are not in active use by the processor 1202. It will be appreciated that the information retained within mass storages 1212 and 1220 can be incorporated, if needed, in standard fashion as part of memory 1210 (e.g., RAM) as virtual memory.

In addition to providing processor 1202 access to storage subsystems, bus 1214 can also be used to provide access to other subsystems and devices. As shown, these can include a display 1218, a network interface 1216, a keyboard 1204, and a pointing device 1208, as well as an auxiliary input/output device interface, a sound card, speakers, and other subsystems as needed. For example, the pointing device 1208 can be a mouse, stylus, track ball, or tablet, and is useful for interacting with a graphical user interface.

The network interface 1216 allows processor 1202 to be coupled to another computer, computer network, or telecommunications network using a network connection as shown. For example, through the network interface 1216, the processor 1202 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 1202 can be used to connect the computer system 1200 to an external network and transfer data according to standard protocols. For example, various process embodiments disclosed herein can be executed on processor 1202, or can be performed across a network such as the Internet, intranet networks, or local area networks, in conjunction with a remote processor that shares a portion of the processing. Additional mass storage devices (not shown) can also be connected to processor 1202 through network interface 1216.

An auxiliary I/O device interface (not shown) can be used in conjunction with computer system 1200. The auxiliary I/O device interface can include general and customized interfaces that allow the processor 1202 to send and, more typically, receive data from other devices such as microphones, touch-sensitive displays, transducer card readers, tape readers, voice or handwriting recognizers, biometrics readers, cameras, portable mass storage devices, and other computers.

Although the present application is disclosed using the embodiments described above, such embodiments cannot be used to limit the present application. Any person with skill in the art can make possible alterations and modifications without departing from the spirit and scope of the present application. Therefore, the scope of protection of the present application shall be the scope defined by the claims of the present application.

In one typical configuration, the computation equipment comprises one or more processors (CPUs), input/output interfaces, network interfaces, and memory.

Memory may include such forms as volatile storage devices in computer-readable media, random access memory (RAM), and/or non-volatile memory, such as read-only memory (ROM) or flash memory (flash RAM). Memory is an example of a computer-readable medium.

Computer readable media include permanent, non-permanent, mobile, and non-mobile media that can be used to store information by any method or technology. Information can be computer-readable commands, data structures, program modules, or other data. Examples of computer storage media include but are not limited to phase-change memory (PRAM), static random access memory (SRAM), dynamic random access memory (DRAM), other types of random access memory (RAM), read-only memory (ROM), electrically erasable programmable read-only memory (EEPROM), flash memory or other memory technology, compact disk read-only memory (CD-ROM), digital versatile disc (DVD) or other optical storage, magnetic cassettes, magnetic tape or magnetic disc storage, or other magnetic storage equipment or any other non-transmission media that can be used to store information that is accessible to computers. As defined in this document, computer-readable media does not include temporary computer-readable media, transitory media, such as modulated data signals and carrier waves.

A person skilled in the art should understand that the embodiments of the present application can be provided as methods, systems, or computer program products. Therefore, the present application may take the form of completely hardware embodiments, completely software embodiments, or embodiments that combine software and hardware. Moreover, the present application may take the form of computer program products implemented on one or more computer-operable storage media (including but not limited to magnetic disk storage, CD-ROMs, and optical storage) containing computer-operable program code.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
receiving an application (app) jump interface trigger with respect to a source object;
extracting, using a processor, a plurality of target app destinations from a set of jump association information corresponding to the source object, wherein at least a portion of the set of jump association information corresponding to the source object is determined based at least in part on historical app usage data;
presenting the plurality of target app destinations corresponding to the source object in a jump interface;
receiving a selection associated with a selected target app destination in the jump interface; and
performing a jump to the selected target app destination using jump link information corresponding to the selected target app destination, wherein the jump link information is included in the set of jump association information corresponding to the source object.

2. The method of claim 1, further comprising:
determining the set of jump association information corresponding to the source object; and
storing the set of jump association information corresponding to the source object.

3. The method of claim 1, further comprising:
determining the set of jump association information corresponding to the source object including by:
obtaining a plurality of candidate target app destinations from one or more sources;
presenting the plurality of candidate target app destinations; and
receiving selections of one or more candidate target app destinations via a user interface; and
storing the one or more candidate target app destinations in the set of jump association information corresponding to the source object.

4. The method of claim 1, further comprising:
determining the set of jump association information corresponding to the source object including by:
obtaining a plurality of candidate target app destinations over a network from an app jump information server that aggregates app registration information from one or more app developer servers;
presenting the plurality of candidate target app destinations; and
receiving selections of one or more candidate target app destinations via a user interface; and
storing the one or more candidate target app destinations in the set of jump association information corresponding to the source object.

5. The method of claim 1, further comprising:
determining the set of jump association information corresponding to the source object including by:
obtaining a plurality of candidate target app destinations from a client device at is which a plurality of apps is installed;
presenting the plurality of candidate target app destinations; and
receiving selections of one or more candidate target app destinations via a user interface; and
storing the one or more candidate target app destinations in the set of jump association information corresponding to the source object.

6. The method of claim 1, further comprising:
determining the set of jump association information corresponding to the source object including by:
obtaining the historical app usage data subsequent to an execution of the source object; and
using a preset selection condition to select one or more target app destinations corresponding to the source object based at least in part on the historical app usage data; and
storing the one or more target app destinations in the set of jump association information corresponding to the source object.

7. The method of claim 1, wherein the jump interface comprises a configuration control that is configurable to enable a user configuration of adding a target app destination to the set of jump association information corresponding to the source object.

8. The method of claim 1, further comprising:
determining that the selected target app destination comprises a target app;
determining that the jump link information corresponding to the selected target app destination in the set of jump association information corresponds to two or more interfaces associated with the target app;
presenting representations associated with the two or more interfaces associated with the target app in a user interface;
receiving a selection associated with an interface associated with the target app; and
performing the jump to the interface associated with the target app using a portion of the jump link information corresponding to the interface associated with the target app.

9. The method of claim 1, further comprising:
determining that the selected target app destination comprises a target app;
determining that the jump link information corresponding to the selected target app destination in the set of jump association information corresponds to one interface associated with the target app; and
performing the jump to the one interface associated with the target app using the jump link information corresponding to the one interface associated with the target app.

10. The method of claim 1, further comprising:
determining that the selected target app destination comprises a specific user interface of a target app; and
performing the jump to a specific user interface of the target app using the jump link information corresponding to the specific user interface of the target app.

11. The method of claim 1, wherein the jump link information corresponding to the selected target app destination comprises one or more deep links to respective ones of one or more interfaces within a target app associated with the selected target app destination.

12. A computer program product, the computer program product comprising a non-transitory computer-readable storage medium and comprising computer instructions for:
receiving an application (app) jump interface trigger with respect to a source object;
extracting a plurality of target app destinations from a set of jump association information corresponding to the source object, wherein at least a portion of the set of jump association information corresponding to the source object is determined based at least in part on historical app usage data;
presenting the plurality of target app destinations corresponding to the source object in a jump interface;
receiving a selection associated with a selected target app destination in the jump interface; and
performing a jump to the selected target app destination using jump link information corresponding to the selected target app destination, wherein the jump link information is included in the set of jump association information corresponding to the source object.

13. The computer program product of claim 12, further comprising:
determining the set of jump association information corresponding to the source object; and
storing the set of jump association information corresponding to the source object.

14. The computer program product of claim 12, further comprising:
determining the set of jump association information corresponding to the source object including by:
obtaining a plurality of candidate target app destinations from one or more sources;
presenting the plurality of candidate target app destinations; and
receiving selections of one or more candidate target app destinations via a user interface; and
storing the one or more candidate target app destinations in the set of jump association information corresponding to the source object.

15. The computer program product of claim 12, further comprising:
determining the set of jump association information corresponding to the source object including by:
obtaining a plurality of candidate target app destinations over a network from an app jump information server that aggregates app registration information from one or more app developer servers;
presenting the plurality of candidate target app destinations; and
receiving selections of one or more candidate target app destinations via a user interface; and
storing the one or more candidate target app destinations in the set of jump association information corresponding to the source object.

16. The computer program product of claim 12, further comprising:
determining the set of jump association information corresponding to the source object including by:
obtaining a plurality of candidate target app destinations from a client device at which a plurality of apps is installed;
presenting the plurality of candidate target app destinations; and
receiving selections of one or more candidate target app destinations via a user interface; and
storing the one or more candidate target app destinations in the set of jump association information corresponding to the source object.

17. The computer program product of claim 12, further comprising:
determining the set of jump association information corresponding to the source object including by:
obtaining the historical app usage data subsequent to an execution of the source object; and
using a preset selection condition to select one or more target app destinations corresponding to the source object based at least in part on the historical app usage data; and
storing the one or more target app destinations in the set of jump association information corresponding to the source object.

18. The computer program product of claim 12, further comprising:
determining that the selected target app destination comprises a target app;
determining that the jump link information corresponding to the selected target app destination in the set of jump association information corresponds to two or more interfaces associated with the target app;
presenting representations associated with the two or more interfaces associated with the target app in a user interface;
receiving a selection associated with an interface associated with the target app; and
performing the jump to the interface associated with the target app using a portion of the jump link information corresponding to the interface associated with the target app.

19. The computer program product of claim 12, wherein the jump link information corresponding to the selected target app destination comprises one or more deep links to respective ones of one or more interfaces within a target app associated with the selected target app destination.

20. A system, comprising:
one or more processors configured to:
receive an application (app) jump interface trigger with respect to a source object;
extract a plurality of target app destinations from a set of jump association information corresponding to the source object, wherein at least a portion of the set of jump association information corresponding to the source object is determined based at least in part on historical app usage data;
present the plurality of target app destinations corresponding to the source object in a jump interface;
receive a selection associated with a selected target app destination in the jump interface; and
perform a jump to the selected target app destination using jump link information corresponding to the selected target app destination, wherein the jump link information is included in the set of jump association information corresponding to the source object; and
one or more memories coupled to the one or more processors and configured to provide the one or more processors with instructions.
